(19) United States
(12) Patent Application Publication
(10) Pub. No.: US 2008/0160941 A1
(43) Pub. Date: Jul. 3, 2008

(54) ASSEMBLY, AND ASSOCIATED METHOD, FOR PROVIDING FOLLOW UP INFORMATION REGARDING RECEIVED CONTENT

(75) Inventor: David R. Moltmaker, Clarkston, MI (US)

Correspondence Address: DOCKET CLERK, P.O. BOX 12608, DALLAS, TX, 75225, US

(73) Assignee: ELECTRONIC DATA SYSTEMS CORPORATION, Plano, TX (US)

(21) Appl. No.: 11/617,907

(22) Filed: Dec. 29, 2006

(51) Int. Cl. H04B 1/18

(52) U.S. Cl. 455/185.1

(57) ABSTRACT

An assembly, and an associated methodology, for providing a listener of content, such as songs played out at a radio receiver of an automotive vehicle, with follow up information related to the content. The listener actuates a user actuator. In response to actuation of the user actuator, a signal is caused to be sent, such as by way of a satellite communication system, that is forwarded on to a data server that stores data related to content. Additional information is retrieved from the data server and information is sent by way of a data message to a computer work station for the listener's subsequent viewing.

The present invention relates generally to a manner by which to provide a recipient of content, such as radio entertainment or advertising content delivered to a radio listener positioned at a motor vehicle, with additional information related to the content. More particularly, the present invention relates to an assembly, and an associated method, for receiving content delivered by way of a first communication medium and for requesting, by way of a second communication medium, more information related to the received content.

Responsive to the request, additional information is obtained and then sent, such as by sending of an e-mail message, containing the information to a communication device, such as a network-connected, computer station, that the user subsequently accesses. The additional information is, most simply, merely a reminder that the request was made. Or, the additional information is a more exhaustive listing associated with the content, or even a downloaded copy of the content.

### BACKGROUND OF THE INVENTION

Advancements in communication technologies have permitted the deployment, and popular usage, of many new types of communication systems. Radio communication systems are amongst communication systems that have made use of such advancements in communication technologies. Existing radio communication services have been improved by including such technological advancements in their operation, and new types of communication systems have been deployed, that utilize such technological advancements.

For instance, new and improved communication services available to an operator of a motor vehicle. While conventional, radio receivers have long been used at the passenger compartment of a motor vehicle, the receivers have generally been able only to receive amplitude-modulated and frequency-modulated signals that are transduced into audio form.

Various radio broadcasting stations are able now to broadcast textual information together with the acoustic content. E.g., song titles, commercial captions, and other brief text segments are sometimes sent, displayable at a display of the radio receiver. Other advancements include digital radio broadcast services that are anticipated to significantly increase the channel capacity of the existing radio bands, providing a corresponding increase in the content available for a listener to receive while positioned in the passenger compartment of the automotive the vehicle, as well as elsewhere.

Other communication services are also available now to many that operate motor vehicles. Two-way satellite, and other, radio communication services provide various safety and security features to those operating motor vehicles. In one exemplary system, for instance, transmissions are automatically sent from the motor vehicle to a service center by way of the satellite communication system upon the occurrence of various events at the motor vehicle. Deployment of a vehicular airbag, e.g., causes an alert message to be generated. Accompanied with the alert indicating the deployment is an indication of the location of the vehicle, and other identifying information, such as the name of the registered user of the vehicle. One such system further provides for telephonic communications between the vehicle and the safety center.

Of course, advancements in communication technologies are not limited to radio communication systems and have been implemented in other types of communication systems. Internet and other packet data network-related communication services, for instance, have experienced nearly explosive growth in recent years. Multimedia and other data-intensive services are regularly now effectuated by way of devices connected to the Internet backbone.

A common scenario for many who regularly listen to radio broadcasts while operating, or otherwise riding in, a motorized vehicle includes listening to a song or other sequence of entertainment content that is broadcast by a radio broadcaster. The radio broadcaster is a terrestrial, or satellite, broadcaster of content. If the performer of the content is also identified, such as by a radio announcer that announces the performer of the content or other identifying information about the content, such as the title or caption associated with the content, the listener is able to make note of the additional information. The listener then must remember the identified information or write down the information for subsequent review. More recently, if the broadcaster broadcasts a textual description of the content and a radio receiver positioned at the motor vehicle is permitting of display of such textual information, the listener's efforts are simplified as the information is displayed at the radio receiver. The listener needs merely to write down the displayed textual information. The listener must have paper and pencil, or another note-taking mechanism available. The listener, of course, must be able to write down the information and must not lose the document upon which the information is copied. If the document is lost or misplaced or if the textual information is something other than the information desired by the listener, the listener must obtain the desired information by other means.

If advantage could be taken of the additional communication systems and services made possible by the additional communication systems and services made possible as a result of advancements in communication technologies, desired information, desired by the listener, could more easily be provided.

It is in light of this background information related to communications services provided by communication systems that the significant improvements of the present invention have evolved.

### SUMMARY OF THE INVENTION

The present invention, accordingly, advantageously provides an assembly, and an associated methodology, by which to provide a recipient of content, such as radio entertainment or advertising content delivered to a radio listener positioned at a motor vehicle, with additional information related to the content.

Through operation of an embodiment of the present invention, a manner is provided by which to receive content delivered by way of a first communication medium and for requesting, by way of a second communication medium, more information related to the received content.

The request for the additional information, sent by way of the second communication medium, is forwarded on to an information element at which information related to the request is stored or maintained. The additional information is retrieved from the information element. Then, the retrieved information is inserted into a data message. And, the data message is sent to a communication device for subsequent retrieval and review. The radio listener sends the request, for instance, when listening to the content and need not write down or otherwise record any information pertaining to the content. The additional information related to the request is sent on to a device to which the listener also has access or to a proxy device of the listener's selection.

In one aspect of the present invention, a receiving station is positioned at a first site, such as the passenger compartment of a motor vehicle. The receiving station receives broadcast content, such as entertainment content or advertising content. Identifiable indicia is also sent with the content, such as a title of entertainment content or the performer that performs the content.

In another aspect of the present invention, a listener, or other recipient, of the content, actuates a user actuator when content is received of which the listener is interested in receiving additional information. The user actuator comprises, for instance, simply a momentary actuation switch depressable by the user to actuate the switch.

In another aspect of the present invention, a radio transmitter is also positioned at the first site. The transmitter operates in a satellite, or other radio communication system. Actuation of the user actuator causes operation of the transmitter to generate and send a message that includes an indication of identifiable indicia associated with the received content of which the listener is interested in receiving more information. The message caused to be sent by the transmitter, e.g., further includes an identification of the registered user of the transmitter or a proxy of the registered user. When the transmitter operates in a satellite communication system, the transmitted message is routed by way of a satellite-based transceiver or transponder that, in turn, interworks with a data network, such as the Internet.

In a further aspect of the present invention, a data server is further provided and maintained at the data network. The message generated at the first site by the transmitter is caused to be routed through the satellite, or other, radio communication system, then forwarded through the data network to the data server. The data server forms an information element. The identifiable indicia contained in the message transmitted by the transmitter is evaluated, and appropriate information indexed together with the indicia is retrieved from the data server and used to populate a new message. In a simplest of implementations, the same information contained in the message transmitted by the transmitter populates the new message with the same information contained in the originally-transmitted message. And, the new message is used merely as a reminder of the earlier actuation of the user actuator. The retrieved information forms, for instance, an address to which the newly-formed message is to routed. In a further implementation, the information retrieved from the data server includes one or more of the title of the content, the author of the content, the performer of the content, lyrics of the contents, etc. when the content forms musical or other entertainment content. When the content forms advertising content, the additional information retrievable by the data server includes, e.g., a source of the advertising, contact information related to the advertiser, sales information pertaining to the content of the advertising, etc. In a yet further implementation, the retrieved information forms an entire copy of the content.

In a further aspect of the present invention, the message formed at, or responsive to access to, the data server is forwarded to a communication device, such as a computer work station associated with the listener, or a proxy of the listener that made the original request for the additional information or to express interest in the content played out by the first-site receiver. The e-mail is sent pursuant to a conventional store-and-forward scheme pursuant in which the e-mail is stored, pending viewing thereof. Or, the e-mail forms a push message, pushed to the communication device. In one implementation, the e-mail forms a set of e-mails in which a first e-mail inquires of the recipient whether the additional information is still desired. If so, a subsequent e-mail is sent containing the additional information. In either implementation, as well as others, the listener is provided with additional information related to the content.

As the listener of the content need only actuate a user actuator, such as a momentary depression switch, to obtain the additional information related to the content, actions required of the listener are minimal. The listener need not write down any information related to the content when the content is played out. Merely by actuating the momentary actuation switch, additional information is provided without further input or instructions provided by the listener.

In these and other aspects, therefore, an assembly, and an associated methodology, provides follow-up information to a user regarding a requested subject. A first site receiving station of a first communication system type is adapted to receive first system receive content. The content is associated with identifiable indicia. A user actuator is configured to be actuated by the user. The actuator is actuated by the user responsive to reception of a selected first site receiving station. A first site transmitting station of a second communication system type is adapted to receive the identifiable indicia associated with the selected first system content. The first site transmitting station is configured to transmit an indication of the identifiable indicia. The indication of the identifiable indicia is used to provide follow up information to the user.

### BRIEF DESCRIPTION OF THE DRAWINGS

FIG. 1 illustrates a functional block diagram of an arrangement of communication systems in which an assembly of the present invention is operable.

FIG. 2 illustrates a representation of an exemplary receiver display responsive to which a listener indicates interest in content by actuating a user actuator.

FIG. 3 illustrates a process diagram representative of the process of operation of an embodiment of the present invention.

FIG. 4 illustrates a method flow diagram representative of the method of operation of an embodiment of the present invention.

### DETAILED DESCRIPTION

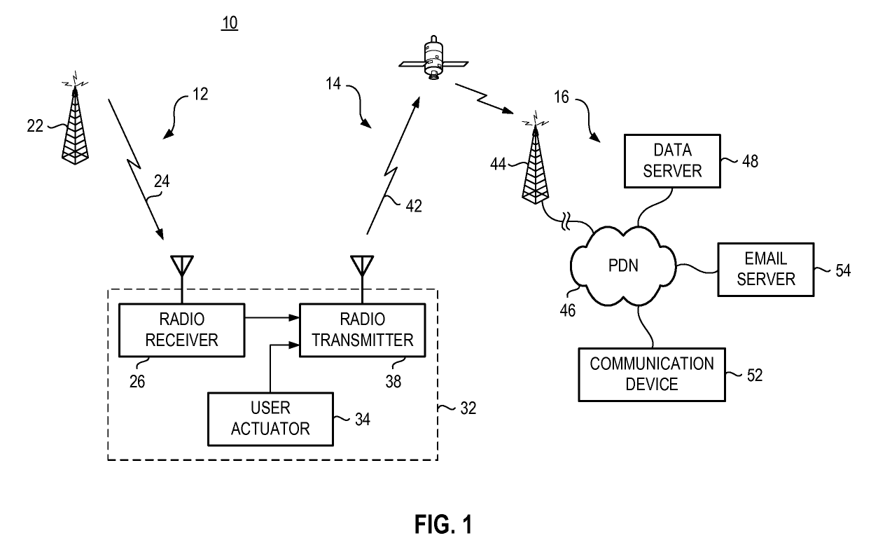

Referring first to FIG. 1, an arrangement, shown generally at 10, is formed of a group of different communication systems, use of which is made pursuant to operation of an embodiment of the present invention. In the exemplary illustration of FIG. 1, a terrestrial, broadcast radio communication system 12, a satellite communication system 14, and a packet data network 16 are all shown. The arrangement is exemplary. In other implementations, other types of communication systems are utilized. While the following description shall describe exemplary operation of an embodiment of the present invention with respect to its implementation in which the arrangement of communication systems corresponds to those shown in FIG. 1, it should be understood that, in other exemplary implementations, other types of communication systems are instead utilized, and the teachings of the present invention are analogously implementable therein.

The terrestrial radio system 12 broadcasts content, such as music or other entertainment or advertising content. In conventional manner, the radio signals are generated and transmitted by a radio transmitter, here represented by the radio tower 22, and the signals are broadcast, here represented by the arrow 24, for delivery to, and reception by, a radio receiver 26. The radio receiver is of a type and construction to permit detection of the transmitted content and to convert the communicated content into human perceptible form, played out, e.g., at a speaker or other acoustic transducer of the receiver. The communication system 12 is analogously representative of a satellite radio system that also broadcasts content, albeit by way of a satellite transmitter rather than a tower-positioned transmitter.

The receiver 26, in the exemplary implementation, is mounted at a motor vehicle, such as at the passenger compartment of an automobile. The receiver is positioned to permit an operator, or passenger, of the vehicle to listen to, or otherwise view, the content delivered to the receiver. As noted above, in some situations, the listener desires to learn additional information related to the content. But, when so-positioned at the vehicle, the listener is sometimes unable to search for the additional information. For instance, if the listener is also operating the motor vehicle, the listener must concentrate on operating the vehicle and is unable to direct much attention or investigation towards the content. And, in any event, when traveling in the motor vehicle, the listener oftentimes does not have access to a mechanism by which to search for additional information related to the content.

The content forms, for instance, musical or other entertainment content or advertising content. The musical or entertainment content typically is performed by a performer, and the content is authored by an author. The content is regularly titled with a content title, and the content sometimes includes lyrics or other characteristics that would be of interest to the listener. And, when the content forms advertising content, the advertising content pertains to an advertiser who is able to be contacted by calling or through an in-person visit at a business location of the advertiser. The advertising content sometimes also includes special offers with respect to products, services, and their pricing. More generally, whatsoever the content that is played out by the receiver, a listener might well be interested in receiving additional information or in some manner being refreshed as to the content that is played out. While some broadcasters of content are able now to include short text segments associated with the content, receivers that are able to make use of the text information, are able merely to display the text information on a visual display that forms part of the receiver. A listener is generally unable to do more than glance at the displayed text. That is to say, the user is oftentimes unable to jot down a note of the displayed text, or the displayed text is different than the information desired by the listener. While the listener is able to rely on memory of the displayed content, the listener sometimes forgets about the display, or the particulars of the content.

Pursuant to an embodiment of the present invention, an assembly 32, here shown to include the receiver 26, provides a mechanism by which to facilitate a listener to note content that is of interest and to initiate retrieval of additional information related to the content for subsequent review.

The assembly also includes a user actuator 34 that is permitting of actuation by a listener of the content played out by the receiver 26. In the exemplary implementation, the user actuator forms a momentary actuation switch. When the listener takes notice of content in which the listener has interest, the listener actuates the user actuator.

Upon actuation of the user actuator, identification indicia associated with the content being played out when the user actuator is actuated, or in close time proximity thereto, is provided to a transmitter (TX) 38. The identification indicia forms, e.g., the text information broadcast together with the content. Additionally, in the exemplary implementation, the transmitter is also provided with an identification of the registered user of the receiver or transmitter.

In the exemplary implementation, and as noted above, the communication system 14 forms a satellite communication system. The transmitter 38 sends transmit signals, here represented by the arrow 42. And, the transmitter is associated with a subscription for service in which the registered operator of the motor vehicle, or other appropriate party, maintains a service subscription. Such information is, e.g., stored at the transmitter 38 or provided thereto by the receiver 26 or pursuant to operation of the user actuator 34.

The signal transmitted by the transmitter 38 includes both the identification indicia associated with the received content and the identification of the registered user, or other appropriate party. The signal is here routed, by way of the satellite transceiver or transponder 42, and delivered to a station 44 of the system that is, in turn, connected to a packet data network (PDN) 46, such as the Internet backbone. The signal is appropriately converted into a format to permit its forwarding by way of the packet data network to a data server 48. The data server 48 includes a data depository of data related to content broadcast to the receiver 26. For instance, when the content forms musical content, the data server forms a musical database containing information related to the musical content as well as, e.g., electronic copies of the content, available for purchase, or the like. Once obtained, a data message is formed for forwarding to a communication device 52 that also forms part of the assembly 32 of an embodiment of the present invention. The message, in one implementation, is routed by way of an e-mail server 54. The e-mail server forms a store-and-forward facility permitting a user of the communication station 52 to access the stored contents of the server. Or, the message forms a push message that is pushed to the communication station 52. And, in other implementations, the information is forwarded to the communication station in other manners, all, however, to provide information to an operator of the communication station. And, in one implementation, a message is forwarded to the communication station to inquire whether additional information related to the content is still desired. If so, the information is retrieved and then forwarded on to the communication station in a two-step procedure of inquiring and receiving. Alternately, and as above-described, the information is retrieved and then forwarded without special request.

Thereby, by the listener of the receiver 26 taking the simple step of actuating the user actuator when content of interest to the listener is received at the receiver, additional information is provided to the communication station 52, permitting subsequent viewing by the listener, or other interested party.

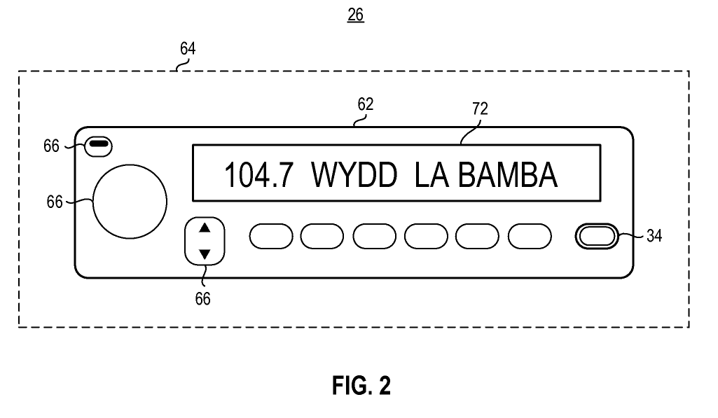

FIG. 2 illustrates a representation of part of the receiver 26 that forms part of the assembly 32 of an embodiment of the present invention. Here, an exemplary radio face 62 of the receiver mounted at a passenger compartment of a motor vehicle. The radio is here mounted at a vehicular dashboard of which a portion 64 is shown is FIG. 2. The receiver includes various control elements 66, such as an on/off switch, a volume switch, and radio frequency preset switches. And, the receiver includes a display 72 that displays various information, here the frequency and call sign of a received radio station together with identifying indicia, here a song title of a song being by the radio station. And, a user actuator 34 of an embodiment of the present invention is also shown. An occupant of the automotive vehicle, upon listening to content that is of interest, actuates the user actuator and initiates retrieval of information related to the content.

For instance, a driver of the vehicle hears a song on the radio while driving. The listener pushes the button forming the user actuator to indicate interest in the song. This actuation causes generation of a signal to be sent from the transmitter to a satellite system, such as On-Star™, together with the name of the song, a brand name, and requestor information. The satellite system sends the information on to a data server, such as a data server associated with the iPod™ account of the listener or a Music Match™ of the listener as well as the e-mail address of the listener. When the listener subsequently operates a personal computer forming the communication station, even if days later, the user is provided with, or asked if the user has interest in receiving, more information related to the song. The listener is asked, e.g., if the user would like to download the song from the iTunes or Music Match server. Alternately, the listener, when operating the personal computer, receives an e-mail inquiring whether the listener has continued interest in the song.

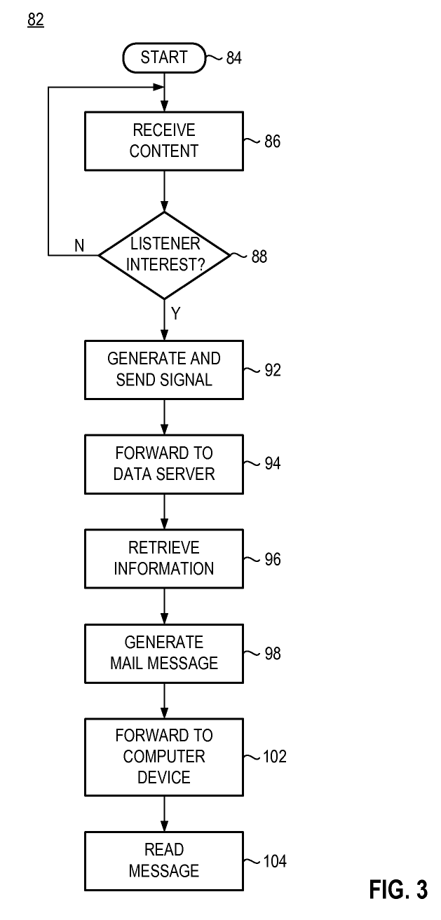

FIG. 3 illustrates a process diagram, shown generally at 82, representative of the process of operation of an embodiment of the present invention. Subsequent to commencement, indicated by the start block 84, content is received, indicated by the block 86. Subsequently, a determination is made, indicated by the decision block 88, as to whether there is listener interest in the received content. If not, the no branch is taken back to the block 86. Otherwise, the yes branch is taken to the block 92.

At the block 92, a signal is generated and caused to be sent by way of the satellite communication system, or other appropriate communication system, and then forwarded, indicated by the block 94, on to a data server. At the data server, and as indicated by the block 96, information related to the content of interest is retrieved. And, as indicated by the block 98, a data message is generated. As indicated by the block 102, the generated message is then forwarded for ultimate delivery to a computer work station associated with the listener or other appropriate user. Then, at the convenience of the listener, the message is read and subsequent action, if desired, is taken.

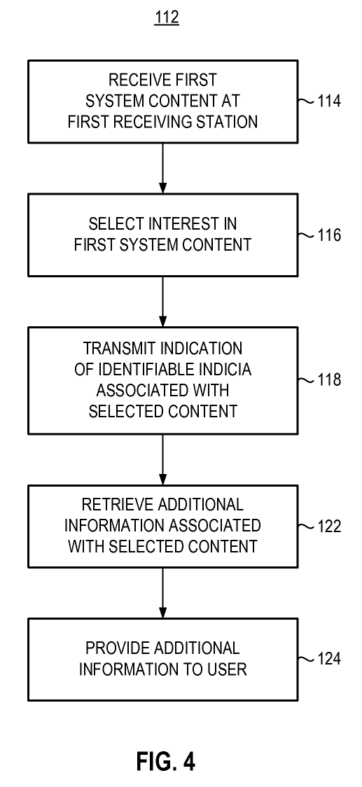

FIG. 4 illustrates a method flow diagram, shown generally at 112, representative of the method of operation of an embodiment of the present invention. The method provides follow up information to a user regarding a requested subject.

First, and as indicated by the block 114, first system content is received at a first site receiving station. The first system content is associated with identifiable indicia. Then, and as indicated by the block 116, a user selects interest in selected first system content received at the first site receiving station.

Thereafter, and as indicated by the block 118, an indication of the identifiable indicia is transmitted. The indication of the identifiable indicia is used to provide the follow up information to the user.

Subsequently, and as indicated by the block 122, additional information related to the indication of the identifiable indicia is retrieved. And, as indicated by the block 124, the additional information is provided to the user.

Thereby, through mere actuation of a single user actuator, a listener of content received at a radio receiver is able to be provided subsequently with additional information related to the content.

What is claimed is:

1. An assembly for providing follow up information to a user regarding a requested subject, said assembly comprising:
a first-site receiving station of a first communication-system type and adapted to receive first-system content, the first-system content associated with identifiable indicia;
a user actuator configured to be actuated by the user responsive to reception of selected first-system content at said first-site receiving station;
a first-site transmitting station of a second communication system type adapted to receive the identifiable indicia associated with the selected first-system content, responsive to reception thereof said user actuator is caused by the user to be actuated, said first-site transmitting station configured to transmit an indication of the identifiable indicia, the indication of the identifiable indicia used to provide the follow up information to the user.

2. The assembly of claim 1 wherein said first-site receiving station comprises a vehicular-mounted radio receiver and wherein the first-system content comprises radio signal broadcasts sent to the vehicular-mounted radio receiver.

3. The assembly of claim 2 wherein the radio signal broadcasts forming the first-system content comprises entertainment content and wherein the identifiable indicia associated with the entertainment content identifies a title of the entertainment content.

4. The assembly of claim 2 wherein the radio signal broadcasts forming the first-system content comprises entertainment content and wherein the identifiable indicia associated with the entertainment content identifies a performer of the entertainment content.

5. The assembly of claim 2 wherein the radio signal broadcasts forming the first-system content comprises advertising content and wherein the identifiable indicia associated with the advertising content identifies a source of the advertising content.

6. The assembly of claim 2 wherein the radio signal broadcasts forming the first-system content comprises advertising content and wherein the identifiable indicia associated with the advertising content identifies a promotion detail of the advertising content.

7. The assembly of claim 2 wherein the radio signal broadcasts forming the first-signal broadcasts received at said first-site receiving station formed of the vehicular-mounted radio receiver comprises a terrestrial radio broadcast.

8. The assembly of claim 1 wherein said first-site transmitting station of the second communication system type comprises a satellite-system transmitter and wherein the second communication system type comprises a satellite communication system.

9. The assembly of claim 1 further comprising a network information station connectable in communication connectivity to receive an inquiry responsive to the indication of the identifiable indicia, said network information station configured to retrieve additional information related to the identifiable indicia.

10. The assembly of claim 9 further comprising a network access station connectable in communication connectivity with said network information station, said network access station configured to receive an indication of the additional information retrieved by said network information station.

11. The assembly of claim 10 wherein said network access station is at least logically associated with the user and at least selectably accessible by the user.

12. The assembly of claim 10 wherein said network access station comprises a packet-data-network-connected, network access station and wherein said network information station comprises a packet-data-network-connected network information station.

13. A method for providing follow-up information to a user regarding a requested subject, said method comprising the operation of:
receiving first-system content at a first-site receiving station, the first-system content associated with identifiable indicia;
selecting, by the user, interest in selected first-system content received at the first-site receiving station; and
transmitting an indication of the identifiable indicia associated with the selected first-system content selected during said operation of selecting, the indication of the identifiable indicia used to provide the follow-up information to the user.

14. The method of claim 13 further comprising the operation of receiving additional information related to the indication of the identifiable indicia.

15. The method of claim 14 further comprising the operation of providing the additional information to the user.

16. The method of claim 14 wherein said operation of transmitting further comprises the operation of transmitting an identity associated with the user.

17. The method of claim 16 wherein said operation of providing comprises providing the additional information to a network access station.

18. The method of claim 13 wherein said operation of transmitting comprises transmitting by way of a second-communication-system by the transmitter the indicator of the identifiable indicia together with an identity associated with the user.

19. The method of claim 18 further comprising the operations of receiving, at a record-communication-system type receiver the indication of the identifiable indicia and the identity of forwarding on the indication and the identity to a third-communication-system type station.

20. The method of claim 19 wherein the first-system content received during said operation of receiving the first-system content comprises broadcast radio system content, wherein the second communication system type transmitter comprises a satellite-system transmitter, and wherein the third-communication-system type station comprises a packet data network station.
